(19) United States
(12) Patent Application Publication
(10) Pub. No.: US 2024/0331013 A1
(43) Pub. Date: Oct. 3, 2024

(54) NOTIFYING USERS ASSOCIATED WITH A SHARED SHOPPING LIST OF A TIME A USER IS PREDICTED TO PLACE AN ORDER WITH AN ONLINE CONCIERGE SYSTEM

(71) Applicant: Maplebear Inc. (dba Instacart), San Francisco, CA (US)

(72) Inventors: Natalia Botía Chaparro, Sunnyvale, CA (US); Sean D'Auria, Portland, OR (US); Rohan Salantry, Walnut Creek, CA (US)

(21) Appl. No.: 18/129,454

(22) Filed: Mar. 31, 2023

(51) Int. Cl. G06Q 30/0601; G06Q 30/0201

(52) U.S. Cl. CPC G06Q 30/0633; G06Q 30/0201

(57) ABSTRACT

An online concierge system receives information describing one or more interactions with a shared shopping list by at least one of multiple users associated with the shared shopping list and identifies a set of attributes associated with the shared shopping list, in which the set of attributes is based at least in part on the interaction(s). The system accesses a machine learning model trained to predict a time that a user associated with the shared shopping list will place an order including one or more items in the shared shopping list and applies the model to the set of attributes to predict the time. The system generates a notification based at least in part on the time that the user is predicted to place the order and sends the notification to one or more client devices associated with one or more users associated with the shared shopping list.

### BACKGROUND

Online concierge systems allow customers to place orders that are fulfilled on their behalf and delivered to them. When placing orders with online concierge systems, customers may specify items and quantities of items to be collected from retailer locations in shopping lists associated with retailers. Since orders may be placed with online concierge systems for entire households, online concierge systems may allow multiple customers to share a shopping list and to place orders including items in the “shared shopping list.” For example, a customer who is an account holder with an online concierge system may invite other customers in their household to interact with a shared shopping list for a grocery store retailer, allowing them to add items to the shared shopping list, modify quantities of the items, place orders including items in the shared shopping list with the online concierge system, etc.

However, multiple customers associated with a shared shopping list may have difficulty coordinating with each other and may fail to add items to the shared shopping list prior to the placement of an order by another customer associated with the shared shopping list. For example, suppose that a customer associated with a shared shopping list for a retailer places an order for the retailer with an online concierge system before other customers in their household associated with the shared shopping list remember to add items to the shared shopping list. In this example, the customers may have to place an additional order for these items and incur additional charges for its fulfillment or do without the items until the next time the customers in the household place an order for the retailer with the online concierge system. Accordingly, as the prevalence of such online concierge systems increases, it may be important to improve the functionality of such systems as pertaining to multi-customer engagement with shared shopping lists.

### SUMMARY

In accordance with one or more aspects of the disclosure, an online concierge system notifies users associated with a shared shopping list of a time another user associated with the shared shopping list is predicted to place an order with the online concierge system. More specifically, an online concierge system receives information describing one or more interactions with a shared shopping list by at least one of multiple users associated with the shared shopping list. The online concierge system identifies a set of attributes associated with the shared shopping list, in which the set of attributes is based at least in part on the interaction(s). The online concierge system then accesses a machine learning model trained to predict a time that a user associated with the shared shopping list will place an order including one or more items in the shared shopping list and applies the machine learning model to the set of attributes to predict the time. The online concierge system generates a notification based at least in part on the time that the user is predicted to place the order and sends the notification to one or more client devices associated with one or more users associated with the shared shopping list.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for notifying users associated with a shared shopping list of a time another user is predicted to place an order with an online concierge system, in accordance with one or more embodiments.

FIGS. 4A-4B illustrate examples of a shared shopping list, in accordance with one or more embodiments.

FIGS. 5A-5B illustrate examples of a notification generated based on a time that a user is predicted to place an order with an online concierge system, in accordance with one or more embodiments.

### DETAILED DESCRIPTION

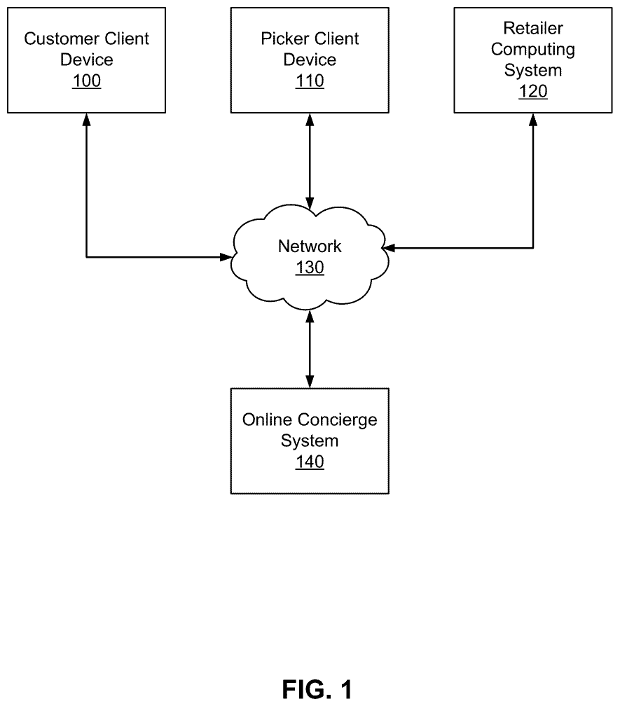

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, refers to a good or product that may be provided to the customer through the online concierge system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the items should be collected. The ordering interface also may allow multiple customers to interact with a “shared shopping list” associated with the customers, which is a tentative set of items that the customers have selected for an order that has not yet been finalized for the order. For example, customers may interact with a shared shopping list by accessing it, adding items to it, removing items from it, modifying quantities of the items in it, providing instructions specifying how the items in it should be collected, placing orders including the items in it, etc. Customers may be associated with a shared shopping list by invitation from another customer. For example, a customer who is an account holder with the online concierge system 140 may invite other customers in their household to add items to a shared shopping list. In some embodiments, customers associated with a shared shopping list may interact with the shared shopping list in a limited number of ways (e.g., based on an invitation or settings specified by a customer who is an account holder with the online concierge system 140). For example, all customers associated with a shared shopping list may access the shared shopping list and add or remove items or modify quantities of the items, but only an account holder with the online concierge system 140 may place orders including items in the shared shopping list.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer location. The picker client device 110 presents the items that are included in the customer's order to the picker in a collection interface. The collection interface is a user interface that provides information to the picker identifying the items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. If a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

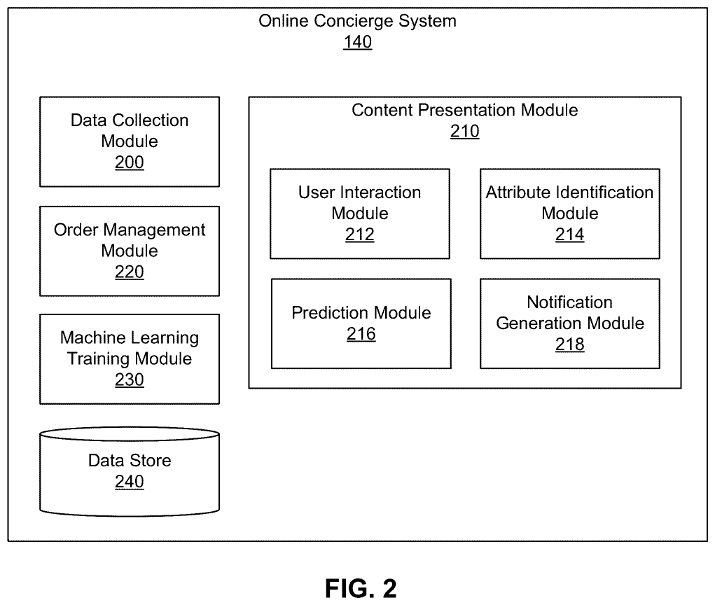

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer. As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

The data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the sizes, colors, weights, stock keeping units (SKUs), or serial numbers for the items. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or a customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, the retailers from which the picker has collected items, or the picker's previous shopping history. Additionally, the picker data may include preferences expressed by the picker, such as their preferred retailers for collecting items, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The data collection module 200 also may collect shopping list data, which is information that describes interactions associated with shopping lists (e.g., shared shopping lists) received from customer client devices 100. For example, shopping list data may include information describing interactions with shopping lists and notifications associated with the shopping lists. The data collection module 200 may collect shopping list data from the content presentation module 210 and its components, which are further described below. Once collected by the data collection module 200, shopping list data may be stored in the data store 240 in association with order data associated with customers who are associated with the shopping list data.

The content presentation module 210 selects content for presentation to a customer. For example, the content presentation module 210 selects which items to present to a customer while the customer is placing an order. Components of the content presentation module 210 include a user interaction module 212, an attribute identification module 214, a prediction module 216, and a notification generation module 218, which are further described below. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In various embodiments, the ordering interface generated and sent by the content presentation module 210 includes a shared shopping list associated with multiple customers. In such embodiments, the shared shopping list may include different sections for items added by different customers associated with the shared shopping list. Furthermore, the ordering interface may include various user interface elements (e.g., buttons, links, text boxes, drop-down menus, scroll bars, toggle switches, etc.) that allow customers associated with a shared shopping list to interact with the shared shopping list or to perform various actions associated with the shared shopping list. For example, the ordering interface may include a “Go to checkout” button that allows a customer to place an order including items in a shared shopping list or a “Send reminder” button that allows the customer to prompt another customer to add items to the shared shopping list. In embodiments in which the ordering interface includes a user interface element, the content presentation module 210 may update, remove, disable, or reset the user interface element. In the above example, once an interaction with the “Send reminder” button is received and a reminder is sent, the content presentation module 210 may disable the button, update it with text (e.g., “Reminder sent”) to indicate that the reminder has been sent, and send it for display to a customer client device 100 from which the interaction was received. Continuing with this example, the content presentation module 210 may reset the “Send reminder” button after a threshold amount of time has elapsed, allowing the reminder to be sent again.

The user interaction module 212 receives information describing interactions with shared shopping lists by customers who are associated with the shared shopping lists. The user interaction module 212 may receive the information from customer client devices 100 associated with the customers or from any other suitable source. As described above, customers may interact with a shared shopping list by accessing it, adding items to it, removing items from it, modifying quantities of the items in it, providing instructions specifying how the items in it should be collected, placing orders including the items in it, etc. Information describing an interaction with a shared shopping list may describe a type of the interaction (e.g., adding or removing an item, modifying a quantity of an item, providing instructions for collecting an item, placing an order including items in the shared shopping list, etc.) and one or more items associated with the interaction (e.g., an identifier or a price/discount associated with each item, a quantity of each item, etc.). Information describing an interaction with a shared shopping list also may include information identifying a customer associated with the interaction (e.g., a name or a client device identifier associated with the customer), information describing a time of the interaction (e.g., a timestamp), information identifying a retailer associated with the shared shopping list, or any other suitable types of information. For example, if the user interaction module 212 receives information describing an interaction with a shared shopping list corresponding to a placement of an order including one or more items in the shared shopping list, the information may include a name of the customer who placed the order, a name of a retailer for which the order was placed, a time at which the order was placed, a total amount spent on the order, a quantity of items included in the order, etc.

In some embodiments, the user interaction module 212 also may receive responses to notifications associated with shared shopping lists sent to customer client devices 100. For example, suppose that a notification reminds a customer to add items to a shared shopping list and is sent to a customer client device 100 associated with the customer. In this example, the user interaction module 212 may receive a response from the customer client device 100 indicating that the customer has accessed the shared shopping list, that the customer needs more time to add items to the shared shopping list, that the customer does not intend to add items to the shared shopping list, etc. The user interaction module 212 may receive a response to a notification in association with various types of information (e.g., information identifying a customer associated with the response, information describing a time the response was received, etc.). In some embodiments, the user interaction module 212 may make various determinations based on responses to notifications associated with shared shopping lists received from customer client devices 100. In the above example, the user interaction module 212 may determine a difference between a time that the notification was sent for display to the customer client device 100 and a time that the response was received from the customer client device 100. In this example, the difference may be stored in the data store 240 in association with various types of information (e.g., information identifying the customer, the content of the response, order data for an order including items in the shared shopping list once the order is placed, etc.).

The attribute identification module 214 identifies a set of attributes associated with a shared shopping list. A set of attributes associated with a shared shopping list may include attributes associated with customers associated with the shared shopping list (e.g., names, preferences, dietary restrictions, geographical locations, etc. associated with the customers included among customer data stored in the data store 240). A set of attributes associated with a shared shopping list also may include attributes associated with a retailer associated with the shared shopping list (e.g., a name, a type, etc. of the retailer received from the retailer computing system 120). In some embodiments, a set of attributes associated with a shared shopping list may be based on information describing one or more interactions with the shared shopping list received by the user interaction module 212. For example, a set of attributes associated with a shared shopping list may include information describing each interaction with the shared shopping list, information identifying a customer who performed each interaction, information describing a time of each interaction, a frequency of the interactions, etc. As an additional example, a set of attributes associated with a shared shopping list may include attributes associated with one or more items included in the shared shopping list as a result of one or more interactions with the shared shopping list. In this example, the set of attributes may include a cost associated with the shared shopping list, a number of items included in the shared shopping list, an identifier, a quantity, a price, a discount, or a type associated with each item, instructions for collecting each item, etc.

The prediction module 216 predicts a time that a customer associated with a shared shopping list will place an order including one or more items in the shared shopping list. The prediction module 216 may predict the time based on a set of attributes associated with the shared shopping list identified by the attribute identification module 214 and historical data associated with one or more previous orders associated with one or more customers who are associated with the shared shopping list. For example, the prediction module 216 may predict a time that a customer associated with a shared shopping list will place an order including one or more items in the shared shopping list based on information identifying each item included in the shared shopping list and a frequency with which each item is included in one or more previous orders associated with some or all of the customers associated with the shared shopping list. In this example, the time predicted by the prediction module 216 may correspond to a number of minutes from a current time, in which the number of minutes is inversely proportional to the frequency with which the item(s) included in the shared shopping list were included in the previous order(s).

In some embodiments, the prediction module 216 also may predict a time that a customer associated with a shared shopping list will place an order including one or more items in the shared shopping list based on one or more thresholds associated with the shared shopping list. Examples of such thresholds include: a threshold number of items included in the shared shopping list, a threshold percentage or number of items included in the shared shopping list that were included in one or more previous orders associated with one or more customers associated with the shared shopping list, a threshold frequency with which one or more customers associated with the shared shopping list interact with the shared shopping list, a threshold cost associated with the shared shopping list, etc. For example, suppose that previous orders including items in a shared shopping list were placed an average of 10 minutes from a time that at least $50.00 worth of items were added to the shared shopping list, in which at least 30% of the items were included among previous orders placed by customers associated with the shared shopping list. In this example, once $50.00 worth of items have been added to the shared shopping list and at least 30% of these items were included among previous orders placed by the customers, the prediction module 216 may predict that a customer associated with the shared shopping list is likely to place an order including items in the shared shopping list in 10 minutes.

In some embodiments, the prediction module 216 may predict a time that a customer associated with a shared shopping list will place an order including one or more items in the shared shopping list using an order time prediction model. The order time prediction model is a machine learning model that is trained to predict a time that a customer associated with a shared shopping list will place an order including one or more items in the shared shopping list. For example, the order time prediction model may be trained to predict a number of minutes from a current time that a customer associated with a shared shopping list will place an order including one or more items in the shared shopping list. The order time prediction model may be trained by the machine learning training module 230 based at least in part on historical data associated with one or more previous orders associated with one or more customers who are associated with a shared shopping list, as described below.

To use the order time prediction model, the prediction module 216 may access the model (e.g., from the data store 240) and apply the model to a set of attributes associated with a shared shopping list. The prediction module 216 may then receive an output from the order time prediction model corresponding to a predicted time that a customer associated with the shared shopping list will place an order including one or more items in the shared shopping list. Alternatively, the prediction module 216 may predict the time based on the output. For example, the prediction module 216 may access and apply the order time prediction model to a set of attributes associated with a shared shopping list, such as information identifying items included in the shared shopping list, a cost associated with the shared shopping list, a number of items included in the shared shopping list, a frequency with which the shared shopping list is being accessed, etc. In this example, the prediction module 216 may then receive an output from the order time prediction model corresponding to a predicted number of minutes from a current time that a customer associated with the shared shopping list will place an order including one or more items included in the shared shopping list. Continuing with this example, if it is 3:00 P.M. and the output indicates that the customer is predicted to place the order in 20 minutes, the prediction module 216 may predict that the customer will place the order at 3:20 P.M.

In some embodiments, the prediction module 216 also may predict a likelihood that a customer associated with a shared shopping list will add an item to the shared shopping list. The prediction module 216 may predict the likelihood based on a set of attributes associated with the shared shopping list identified by the attribute identification module 214 and historical data associated with one or more previous orders associated with one or more customers who are associated with the shared shopping list. For example, suppose that a customer has always added at least three items to a shared shopping list before previous orders including items in the shared shopping list were placed and that one of the items was almost always orange juice. In this example, if the shared shopping list already includes at least three items added by the customer and at least one of the items is orange juice, the prediction module 216 may predict only a 5% likelihood that the customer will add another item to the shared shopping list. Alternatively, in the above example, if the shared shopping list only includes one item added by the customer and the item is not orange juice, the prediction module 216 may predict a 95% likelihood that the customer will add another item to the shared shopping list.

In some embodiments, the prediction module 216 may predict a likelihood that a customer associated with a shared shopping list will add an item to the shared shopping list using an item addition prediction model. The item addition prediction model is a machine learning model that is trained to predict a likelihood that a customer associated with a shared shopping list will add an item to the shared shopping list. The item addition prediction model may be trained by the machine learning training module 230 based at least in part on historical data associated with one or more previous orders associated with one or more customers who are associated with a shared shopping list, as described below.

To use the item addition prediction model, the prediction module 216 may access the model (e.g., from the data store 240) and apply the model to a set of attributes associated with a shared shopping list. The prediction module 216 may then receive an output from the item addition prediction model corresponding to a predicted likelihood that a customer associated with the shared shopping list will add an item to the shared shopping list. For example, the prediction module 216 may access and apply the item addition prediction model to a set of attributes associated with a shared shopping list, such as information identifying items included in the shared shopping list, information identifying each customer who added an item to the shared shopping list, a quantity of each item included in the shared shopping list, etc. In this example, the prediction module 216 may then receive an output from the item addition prediction model corresponding to a predicted likelihood that a customer associated with the shared shopping list will add an item to the shared shopping list (e.g., as a percentage that is proportional to the likelihood).

The notification generation module 218 generates notifications (e.g., push notifications) associated with shared shopping lists that are sent for display to customer client devices 100 associated with customers who are associated with the shared shopping lists. The notifications may include text, images, videos, user interface elements (e.g., buttons, text boxes, etc. allowing the customers to respond to the notifications), or any other suitable types of content. In various embodiments, the notification generation module 218 may generate a notification based on a time that a customer associated with a shared shopping list is predicted to place an order including one or more items in the shared shopping list. In such embodiments, the notification may include the time that the customer is predicted to place the order, a reminder or a suggestion to add one or more items to the shared shopping list, or any other suitable types of information. For example, the notification generation module 218 may generate a notification that includes a number of minutes from a current time that a first customer associated with a shared shopping list is predicted to place an order including one or more items in the shared shopping list. In this example, the notification may, additionally or alternatively, include a suggestion for a second customer associated with the shared shopping list to add one or more items to the shared shopping list prior to the time that the first customer is predicted to place the order.

Additionally or alternatively, the notification generation module 218 may generate a notification associated with a shared shopping list based on a predicted likelihood that a customer associated with the shared shopping list will add an item to the shared shopping list. In such embodiments, the notification may include the likelihood that the customer will add an item to the shared shopping list, a suggestion to delay placing an order including one or more items in the shared shopping list, or any other suitable types of information. For example, if a predicted likelihood that a customer associated with a shared shopping list will add an item to the shared shopping list is at least a threshold likelihood, the notification generation module 218 may generate a notification that indicates the likelihood or a suggestion to delay placing an order until the customer has added one or more items to the shared shopping list.

In various embodiments, the notification generation module 218 may generate a notification associated with a shared shopping list upon receiving a request from a customer client device 100. In such embodiments, the request may be to send a reminder to one or more customers associated with a shared shopping list to add items to the shared shopping list, to place an order including one or more items in the shared shopping list, or any other suitable types of requests. For example, suppose that a request is received from a customer client device 100 associated with a first customer to send a reminder to a second customer to add items to a shared shopping list (e.g., when information describing an interaction with a “Send reminder” button in the ordering interface associated with the second customer is received by the user interaction module 212). In this example, the notification generation module 218 may generate a notification including a reminder for the second customer to add items to the shared shopping list. As an additional example, suppose that a request is received from a customer client device 100 associated with a first customer to place an order (e.g., when information describing an interaction with a “Go to checkout” button associated with a shared shopping list in the ordering interface is received by the user interaction module 212). In this example, the notification generation module 218 may generate a notification that includes predicted likelihoods that other customers associated with the shared shopping list will add items to the shared shopping list, a suggestion to delay placing the order until the customers have added items to the shared shopping list, etc.

In some embodiments, once an order including one or more items in a shared shopping list has been placed, the notification generation module 218 may generate a notification that indicates a timeframe within which customers associated with a shared shopping list may still add items to the shared shopping list in order for the items to be included in the order. In such embodiments, the timeframe may be determined by the order management module 220, which is described below (e.g., based on a time that the order management module 220 assigns the order to a picker for service, based on an estimated amount of time that it would take the picker to collect one or more items included in the order, etc.). For example, once an order including one or more items in a shared shopping list is placed, the notification generation module 218 may generate a notification that describes a timeframe for adding additional items to the shared shopping list, in which the timeframe ends when a picker servicing the order has collected the item(s) in the shared shopping list. In embodiments in which the notification generation module 218 generates such a notification, the notification generation module 218 may update the timeframe or generate one or more additional notifications with updated timeframes (e.g., as the order management module 220 tracks the progress of the picker, as further described below).

Once the notification generation module 218 generates a notification associated with a shared shopping list, the content presentation module 210 may send the notification for display to one or more customer client devices 100 associated with one or more customers associated with the shared shopping list. In various embodiments, a notification associated with a shared shopping list may be sent to one or more customer client devices 100 based on historical data corresponding to one or more previous orders of one or more customers who are associated with the shared shopping list. For example, suppose that for previous orders associated with customers associated with a shared shopping list, an average difference between a time that a notification was sent for display to a customer client device 100 associated with a first customer and a time that a response was received from the customer client device 100 was 20 minutes. In this example, suppose also that the prediction module 216 predicts that a second customer associated with the shared shopping list is likely to place an order including items in the shared shopping list in one hour and that the notification generation module 218 generates a notification indicating when the order is likely to be placed. Continuing with this example, based on the average response time of 20 minutes for the first customer and the time that the second customer is likely to place the order, the content presentation module 210 may send the notification to the customer client device 100 associated with the first customer at a time that will likely allow the first customer sufficient time to add items to the shared shopping list before the order is placed.

In various embodiments, upon receiving a response from a customer client device 100 to a notification associated with a shared shopping list, the notification generation module 218 may generate an additional notification, which the content presentation module 210 may send for display to one or more customer client devices 100 associated with one or more customers associated with the shared shopping list. For example, suppose that a notification including a reminder to add items to a shared shopping list is sent to a customer client device 100 and a response is received from the customer client device 100 via the user interaction module 212 indicating that a customer associated with the customer client device 100 needs 10 minutes to add items to the shared shopping list. In this example, based on the response, the notification generation module 218 may generate an additional notification indicating that the customer needs 10 minutes to add items to the shared shopping list and the content presentation module 210 may send the additional notification to another customer client device 100 from which a request to place an order including items in the shared shopping list was received.

The order management module 220 manages orders for items from customers. The order management module 220 receives orders from customer client devices 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer who placed the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit instructions to the picker client device 110 to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model is used by the machine learning model to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

In embodiments in which the prediction module 216 accesses the order time prediction model that is trained to predict a time that a customer associated with a shared shopping list will place an order including one or more items in the shared shopping list, the machine learning training module 230 may train the order time prediction model. The machine learning training module 230 may train the order time prediction model via supervised learning based on historical data associated with one or more previous orders associated with one or more customers who are associated with the shared shopping list. The historical data may include various types of information associated with the previous order(s). For example, the historical data may include information identifying one or more items included in each previous order, a number of items included in each previous order, a cost associated with each previous order, a recipe associated with each previous order, a frequency with which the previous orders were placed, a retailer associated with each previous order, and a retailer associated with a shopping list associated with each previous order. As an additional example, the historical data may include a time at which an item was added to a shared shopping list associated with each previous order, information identifying a customer adding an item to a shared shopping list associated with each previous order, a time at which each previous order was placed, and information identifying a customer placing each previous order. As yet another example, the historical data may include a time at which a shared shopping list associated with each previous order was accessed, information describing an interaction with a shared shopping list associated with each previous order, and information identifying a customer interacting with a shared shopping list associated with each previous order. As another example, the historical data may include information associated with one or more notifications associated with each previous order, a frequency with which a shared shopping list associated with each previous order was accessed (e.g., at each of multiple timeframes prior to the placement of each previous order), a frequency with which an item was included in the previous orders, etc. In the above example, information associated with a notification may include the content of the notification, a time at which the notification was sent, information identifying a customer associated with a customer client device 100 to which the notification was sent, whether a response to the notification was received, the content of the response, etc.

To illustrate an example of how the order time prediction model may be trained, suppose that the machine learning training module 230 receives a set of training examples. In this example, the set of training examples may include attributes of one or more previous orders associated with one or more customers associated with a shared shopping list, such as information identifying items included in each previous order, a frequency with which the previous orders were placed, information identifying a customer who placed each previous order, etc. In the above example, the attributes of the previous order(s) also may be associated with one or more shopping lists (e.g., shared shopping lists) associated with the previous order(s), such as times at which a shopping list was accessed, a time at which an item was added to a shopping list, information identifying a customer adding an item to a shopping list, etc. Continuing with this example, the attributes of the previous order(s) also may be associated with one or more retailers (e.g., their names, geographical locations, types, etc.), customers (e.g., their names, preferences, dietary restrictions, etc.), or notifications (e.g., their contents, the contents of responses to the notifications, the response times, etc.) associated with the previous order(s). In this example, the machine learning training module 230 also may receive labels which represent expected outputs of the order time prediction model, in which a label indicates a time that a customer associated with a shared shopping list placed a previous order. Continuing with this example, the machine learning training module 230 may then train the order time prediction model based on the attributes as well as the labels by comparing its output from input data of each training example to the label for the training example.

In embodiments in which the prediction module 216 accesses the item addition prediction model that is trained to predict a likelihood that a customer associated with a shared shopping list will add an item to the shared shopping list, the machine learning training module 230 may train the item addition prediction model. The machine learning training module 230 may train the item addition prediction model via supervised learning based on historical data associated with one or more previous orders associated with one or more customers who are associated with the shared shopping list. As described above, the historical data may include various types of information associated with the previous order(s) (e.g., information identifying one or more items included in each previous order, a time at which an item was added to a shared shopping list associated with each previous order, a frequency with which a shared shopping list associated with each previous order was accessed, etc.).

To illustrate an example of how the item addition prediction model may be trained, suppose that the machine learning training module 230 receives a set of training examples. In this example, the set of training examples may include attributes of one or more previous orders associated with one or more customers associated with a shared shopping list, such as information identifying items included in each previous order, a frequency with which the previous orders were placed, information identifying a customer who placed each previous order, etc. In the above example, the attributes of the previous order(s) also may be associated with one or more shopping lists (e.g., shared shopping lists) associated with the previous order(s), such as times at which a shopping list was accessed, a time at which an item was added to a shopping list, information identifying a customer adding an item to a shopping list, etc. Continuing with this example, the attributes of the previous order(s) also may be associated with one or more retailers (e.g., their names, geographical locations, types, etc.), customers (e.g., their names, preferences, dietary restrictions, etc.), or notifications (e.g., their contents, the contents of responses to the notifications, the response times, etc.) associated with the previous order(s). In this example, the machine learning training module 230 also may receive labels which represent expected outputs of the item addition prediction model, in which a label indicates whether a customer associated with a shared shopping list added one or more items to a shopping list before a previous order including one or more items in the shopping list was placed. Continuing with this example, the machine learning training module 230 may then train the item addition prediction model based on the attributes as well as the labels by comparing its output from input data of each training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, picker data, and shopping list data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

Notifying Users Associated with a Shared Shopping List of a Time a User is Predicted to Place an Order with an Online Concierge System

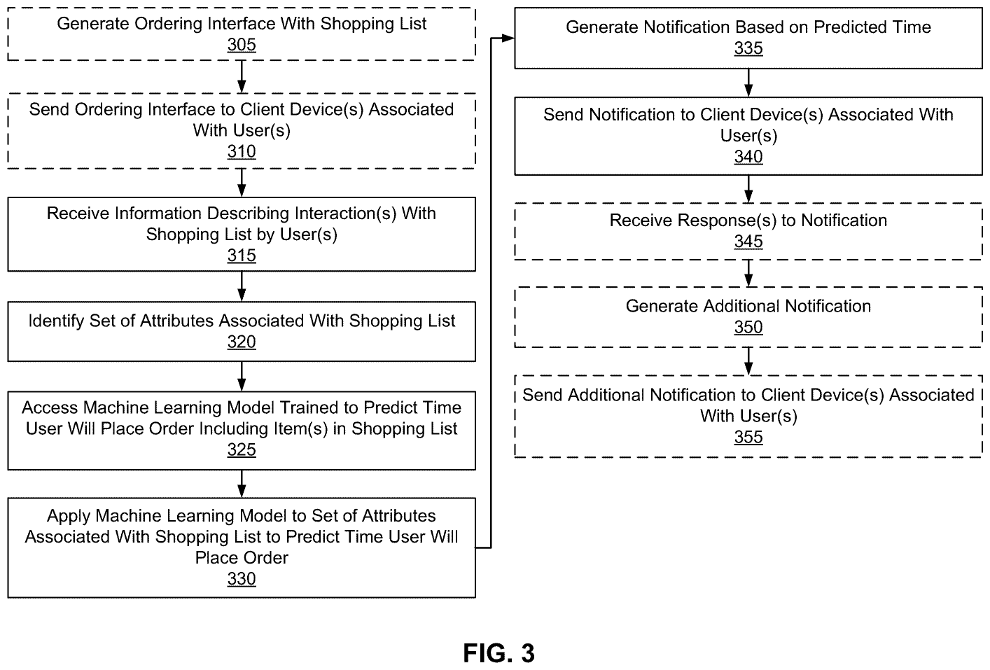

FIG. 3 is a flowchart of a method for notifying users associated with a shared shopping list of a time another user is predicted to place an order with an online concierge system 140, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system 140 without human intervention.

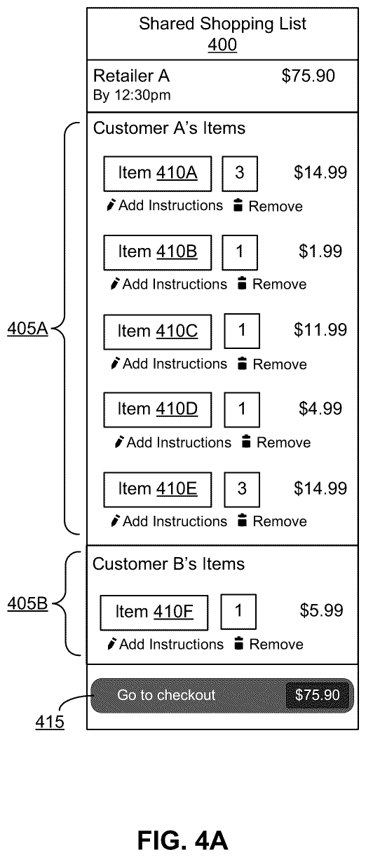

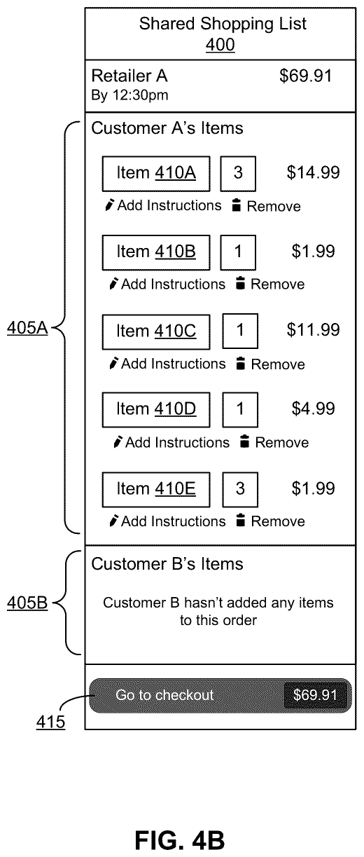

The online concierge system 140 may generate 305 (e.g., using the content presentation module 210) an ordering interface that includes a shared shopping list associated with multiple customers and send 310 (e.g., using the content presentation module 210) the ordering interface to one or more customer client devices 100 associated with one or more of the customers. As shown in FIGS. 4A-4B, which illustrate examples of a shared shopping list 400, in accordance with one or more embodiments, different sections 405 of the shared shopping list 400 may include different sets of items 410 added by different customers associated with the shared shopping list 400. For example, as shown in FIG. 4A, a section 405A of the shared shopping list 400 may include multiple items 410A-E added by Customer A, while another section 405B includes one item 410F added by Customer B. As an additional example, as shown in FIG. 4B, a section 405B of the shared shopping list 400 may be empty, indicating that a customer associated with that section 405B (i.e., Customer B) has not added any items 410 to the shared shopping list 400. Furthermore, the ordering interface may include various user interface elements (e.g., buttons, links, text boxes, drop-down menus, scroll bars, toggle switches, etc.) that allow customers associated with the shared shopping list 400 to interact with the shared shopping list 400 or to perform various actions associated with the shared shopping list 400. For example, the ordering interface may include a “Go to checkout” button 415 that allows a customer associated with the shared shopping list 400 to place an order including items 410 in the shared shopping list 400, as shown in FIGS. 4A-4B.

Referring back to FIG. 3, the online concierge system 140 receives 315 (e.g., via the user interaction module 212) information describing one or more interactions with the shared shopping list 400 by one or more customers who are associated with the shared shopping list 400. The online concierge system 140 may receive 315 the information from one or more customer client devices 100 associated with the customer(s) or from any other suitable source. The customer(s) may interact with the shared shopping list 400 by accessing it, adding items 410 to it, removing items 410 from it, modifying quantities of the items 410 in it, providing instructions specifying how the items 410 in it should be collected, placing orders including the items 410 in it, etc. The information describing the interaction(s) may describe a type of each interaction (e.g., adding or removing an item 410, modifying a quantity of an item 410, providing instructions for collecting an item 410, placing an order including items 410 in the shared shopping list 400, etc.) and one or more items 410 associated with each interaction (e.g., an identifier or a price/discount associated with each item 410, a quantity of each item 410, etc.). The information describing the interaction(s) also may include information identifying one or more customers associated with the interaction(s) (e.g., a name or a client device identifier associated with each customer), information describing one or more times of the interaction(s) (e.g., timestamps), information identifying a retailer associated with the shared shopping list 400, or any other suitable types of information. For example, if the online concierge system 140 receives 315 information describing an interaction corresponding to a placement of an order including the item(s) 410 in the shared shopping list 400, the information may include a name of the customer who placed the order, a name of a retailer for which the order was placed, a time at which the order was placed, a total amount spent on the order, a quantity of items 410 included in the order, etc.

The online concierge system 140 then identifies 320 (e.g., using the attribute identification module 214) a set of attributes associated with the shared shopping list 400. The set of attributes associated with the shared shopping list 400 may include attributes associated with customers associated with the shared shopping list 400 (e.g., names, preferences, dietary restrictions, geographical locations, etc. associated with the customers included among customer data stored in the data store 240). The set of attributes associated with the shared shopping list 400 also may include attributes associated with a retailer associated with the shared shopping list 400 (e.g., a name, a type, etc. of the retailer received from the retailer computing system 120). In some embodiments, the set of attributes associated with the shared shopping list 400 may be based on the information describing the interaction(s) with the shared shopping list 400 received 315 by the online concierge system 140. For example, the set of attributes associated with the shared shopping list 400 may include information describing each interaction with the shared shopping list 400, information identifying a customer who performed each interaction, information describing a time of each interaction, a frequency of the interactions, etc. As an additional example, the set of attributes associated with the shared shopping list 400 may include attributes associated with one or more items 410 included in the shared shopping list 400 as a result of the interaction(s) with the shared shopping list 400. In this example, the set of attributes may include a cost associated with the shared shopping list 400, a number of items 410 included in the shared shopping list 400, an identifier, a quantity, a price, a discount, or a type associated with each item 410, instructions for collecting each item 410, etc.

The online concierge system 140 then predicts (e.g., using the prediction module 216) a time that a customer associated with the shared shopping list 400 will place an order including one or more items 410 in the shared shopping list 400. The online concierge system 140 may predict the time based on the set of attributes associated with the shared shopping list 400 and historical data associated with one or more previous orders associated with one or more customers who are associated with the shared shopping list 400. For example, the online concierge system 140 may predict the time that a customer associated with the shared shopping list 400 will place an order including the item(s) 410 in the shared shopping list 400 based on information identifying each item 410 included in the shared shopping list 400 and a frequency with which each item 410 is included in one or more previous orders associated with some or all of the customers associated with the shared shopping list 400. In this example, the time predicted by the online concierge system 140 may correspond to a number of minutes from a current time, in which the number of minutes is inversely proportional to the frequency with which the item(s) 410 included in the shared shopping list 400 were included in the previous order(s).

In some embodiments, the online concierge system 140 also may predict the time that a customer associated with the shared shopping list 400 will place an order including the item(s) 410 in the shared shopping list 400 based on one or more thresholds associated with the shared shopping list 400. Examples of such thresholds include: a threshold number of items 410 included in the shared shopping list 400, a threshold percentage or number of items 410 included in the shared shopping list 400 that were included in one or more previous orders associated with one or more customers associated with the shared shopping list 400, a threshold frequency with which one or more customers associated with the shared shopping list 400 interact with the shared shopping list 400, a threshold cost associated with the shared shopping list 400, etc. For example, suppose that previous orders including items 410 in the shared shopping list 400 were placed an average of 10 minutes from a time that at least $50.00 worth of items 410 were added to the shared shopping list 400, in which at least 30% of the items 410 were included among previous orders placed by customers associated with the shared shopping list 400. In this example, once $50.00 worth of items 410 have been added to the shared shopping list 400 and at least 30% of these items 410 were included among previous orders placed by the customers, the online concierge system 140 may predict that a customer associated with the shared shopping list 400 is likely to place an order including items 410 in the shared shopping list 400 in 10 minutes.

In some embodiments, the online concierge system 140 may predict the time that a customer associated with the shared shopping list 400 will place an order including the item(s) 410 in the shared shopping list 400 using an order time prediction model. The order time prediction model is a machine learning model that is trained to predict a time that a customer associated with a shared shopping list 400 will place an order including one or more items 410 in the shared shopping list 400. For example, the order time prediction model may be trained to predict a number of minutes from a current time that a customer associated with a shared shopping list 400 will place an order including one or more items 410 in the shared shopping list 400. The order time prediction model may be trained by the online concierge system 140 (e.g., using the machine learning training module 230) based at least in part on the historical data associated with one or more previous orders associated with one or more customers who are associated with the shared shopping list 400.

To use the order time prediction model, the online concierge system 140 may access 325 (e.g., using the prediction module 216) the model (e.g., from the data store 240) and apply 330 (e.g., using the prediction module 216) the model to the set of attributes associated with the shared shopping list 400. The online concierge system 140 may then receive an output from the order time prediction model corresponding to the predicted time that a customer associated with the shared shopping list 400 will place an order including the item(s) 410 in the shared shopping list 400. Alternatively, the online concierge system 140 may predict the time based on the output. For example, the online concierge system 140 may access 325 and apply 330 the order time prediction model to the set of attributes associated with the shared shopping list 400, such as information identifying items 410 included in the shared shopping list 400, a cost associated with the shared shopping list 400, a number of items 410 included in the shared shopping list 400, a frequency with which the shared shopping list 400 is being accessed, etc. In this example, the online concierge system 140 may then receive an output from the order time prediction model corresponding to a predicted number of minutes from a current time that a customer associated with the shared shopping list 400 will place an order including the item(s) 410 included in the shared shopping list 400. Continuing with this example, if it is 3:00 P.M. and the output indicates that the customer is predicted to place the order in 20 minutes, the online concierge system 140 may predict that the customer will place the order at 3:20 P.M.

In some embodiments, the online concierge system 140 also may predict (e.g., using the prediction module 216) a likelihood that a customer associated with the shared shopping list 400 will add an item 410 to the shared shopping list 400. The online concierge system 140 may predict the likelihood based on the set of attributes associated with the shared shopping list 400 and the historical data associated with one or more previous orders associated with one or more customers who are associated with the shared shopping list 400. For example, suppose that a customer has always added at least three items 410 to the shared shopping list 400 before previous orders including items 410 in the shared shopping list 400 were placed and that one of the items 410 was almost always orange juice. In this example, if the shared shopping list 400 already includes at least three items 410 added by the customer and at least one of the items 410 is orange juice, the online concierge system 140 may predict only a 5% likelihood that the customer will add another item 410 to the shared shopping list 400. Alternatively, in the above example, if the shared shopping list 400 only includes one item 410 added by the customer and the item 410 is not orange juice, the online concierge system 140 may predict a 95% likelihood that the customer will add another item 410 to the shared shopping list 400.

In some embodiments, the online concierge system 140 may predict the likelihood that a customer associated with the shared shopping list 400 will add an item 410 to the shared shopping list 400 using an item addition prediction model. The item addition prediction model is a machine learning model that is trained to predict a likelihood that a customer associated with a shared shopping list 400 will add an item 410 to the shared shopping list 400. The item addition prediction model may be trained by the online concierge system 140 (e.g., using the machine learning training module 230) based at least in part on the historical data associated with one or more previous orders associated with one or more customers who are associated with the shared shopping list 400.

To use the item addition prediction model, the online concierge system 140 may access (e.g., using the prediction module 216) the model (e.g., from the data store 240) and apply (e.g., using the prediction module 216) the model to the set of attributes associated with the shared shopping list 400. The online concierge system 140 may then receive an output from the item addition prediction model corresponding to the predicted likelihood that a customer associated with the shared shopping list 400 will add an item 410 to the shared shopping list 400. For example, the online concierge system 140 may access and apply the item addition prediction model to the set of attributes associated with the shared shopping list 400, such as information identifying items 410 included in the shared shopping list 400, information identifying each customer who added an item 410 to the shared shopping list 400, a quantity of each item 410 included in the shared shopping list 400, etc. In this example, the online concierge system 140 may then receive an output from the item addition prediction model corresponding to the predicted likelihood that a customer associated with the shared shopping list 400 will add an item 410 to the shared shopping list 400 (e.g., as a percentage that is proportional to the likelihood).

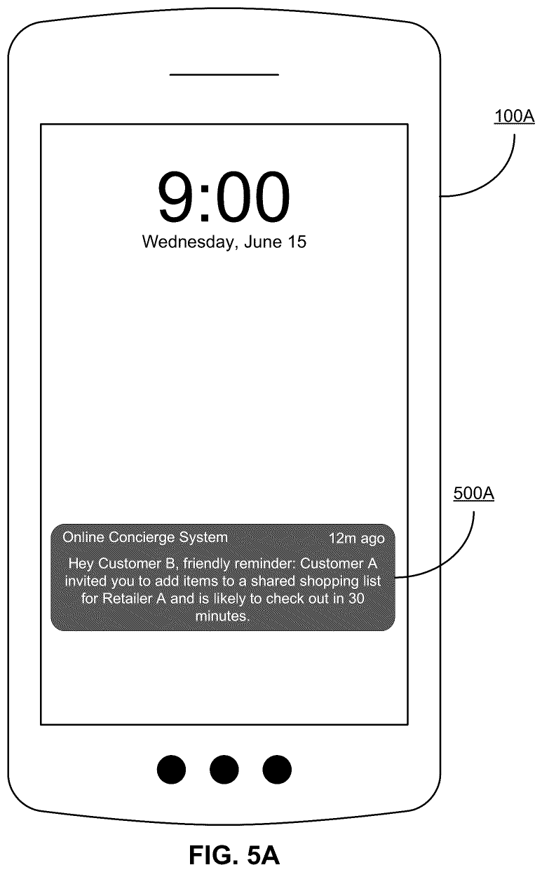

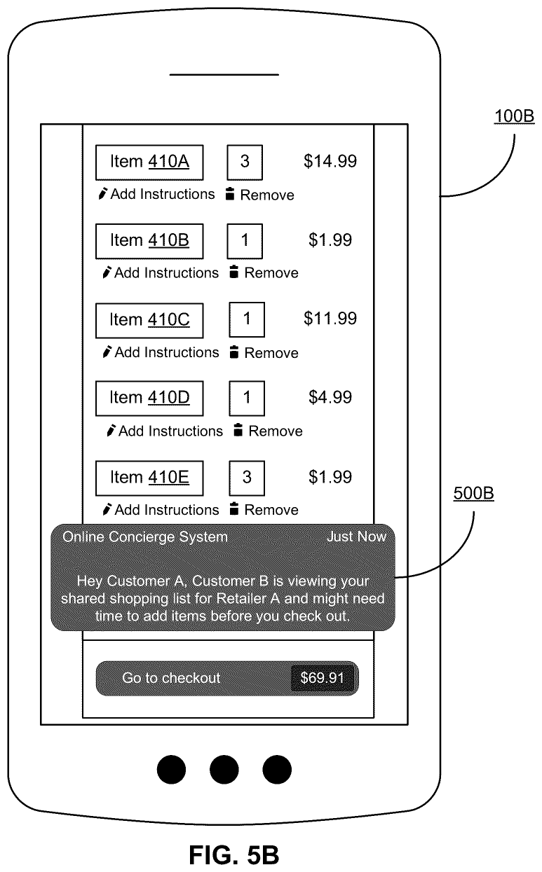

The online concierge system 140 then generates 335 (e.g., using the notification generation module 218) a notification (e.g., a push notification) associated with the shared shopping list 400 and sends 340 (e.g., using the content presentation module 210) the notification for display to one or more customer client devices 100 associated with one or more customers associated with the shared shopping list 400. The notification may include text, images, videos, user interface elements (e.g., buttons, text boxes, etc. allowing a customer to respond to the notification), or any other suitable types of content. In embodiments in which the online concierge system 140 predicts the time that a customer associated with the shared shopping list 400 will place an order including the item(s) 410 in the shared shopping list 400, the online concierge system 140 may generate 335 the notification based on the prediction. In such embodiments, the notification may include the time that the customer is predicted to place the order, a reminder or a suggestion to add one or more items 410 to the shared shopping list 400, or any other suitable types of information. FIGS. 5A-5B illustrate examples of a notification 500 generated 335 based on a time that a user is predicted to place an order with an online concierge system 140, in accordance with one or more embodiments and continue the examples described above in conjunction with FIGS. 4A-4B. As shown in the example of FIG. 5A, the notification 500A generated 335 by the online concierge system 140 that is sent 340 to a customer client device 100A associated with Customer B may indicate that Customer A is predicted to place an order including the item(s) 410 in the shared shopping list 400 in 30 minutes. As shown In this example, the notification 500A also may include a reminder for Customer B to add items 410 to the shared shopping list 400.

In embodiments in which the online concierge system 140 predicts the likelihood that a customer associated with the shared shopping list 400 will add an item 410 to the shared shopping list 400, the online concierge system 140 also or alternatively may generate 335 the notification 500 based on the predicted likelihood. In such embodiments, the notification 500 may include the likelihood that the customer will add an item 410 to the shared shopping list 400, a suggestion to delay placing an order including the item(s) 410 in the shared shopping list 400, or any other suitable types of information. For example, as shown in FIG. 5B, if the predicted likelihood that Customer B will add an item 410 to the shared shopping list 400 is at least a threshold likelihood, the notification 500B generated 335 by the online concierge system 140 that is sent 340 to a customer client device 100B associated with Customer A may include a suggestion to delay placing an order until Customer B has added one or more items 410 to the shared shopping list 400.

In various embodiments, the online concierge system 140 may generate 335 the notification 500 upon receiving a request from a customer client device 100. In such embodiments, the request may be to send a reminder to one or more customers associated with the shared shopping list 400 to add items 410 to the shared shopping list 400, to place an order including the item(s) 410 in the shared shopping list 400, or any other suitable types of requests. For example, suppose that a request is received from a customer client device 100 associated with a first customer to send a reminder to a second customer to add items 410 to the shared shopping list 400 (e.g., when information describing an interaction with a “Send reminder” button in the ordering interface associated with the second customer is received 315 by the online concierge system 140 via the user interaction module 212). In this example, the notification 500 generated 335 by the online concierge system 140 may include a reminder for the second customer to add items 410 to the shared shopping list 400. As an additional example, suppose that a request is received from a customer client device 100 associated with a first customer to place an order (e.g., when information describing an interaction with a “Go to checkout” button associated with the shared shopping list 400 in the ordering interface is received 315 by the online concierge system 140 via the user interaction module 212). In this example, the notification 500 generated 335 by the online concierge system 140 may include predicted likelihoods that other customers associated with the shared shopping list 400 will add items 410 to the shared shopping list 400, a suggestion to delay placing the order until the customers have added items 410 to the shared shopping list 400, etc.

In some embodiments, the notification 500 may be sent 340 to one or more customer client devices 100 based on historical data associated with one or more previous orders associated with one or more customers who are associated with the shared shopping list 400. For example, suppose that for previous orders associated with customers associated with the shared shopping list 400, an average difference between a time that a notification 500 was sent 340 for display to a customer client device 100 associated with a first customer and a time that a response was received from the customer client device 100 was 20 minutes. In this example, suppose also that the online concierge system 140 predicts that a second customer associated with the shared shopping list 400 is likely to place an order including items 410 in the shared shopping list 400 in one hour and that the notification 500 generated 335 by the online concierge system 140 indicates when the order is likely to be placed. Continuing with this example, based on the average response time of 20 minutes for the first customer and the time that the second customer is likely to place the order, the online concierge system 140 may send 340 the notification 500 to the customer client device 100 associated with the first customer at a time that will likely allow the first customer sufficient time to add items 410 to the shared shopping list 400 before the order is placed.

Referring again to FIG. 3, in some embodiments, the online concierge system 140 may receive 345 (e.g., via the user interaction module 212) one or more responses to the notification 500 sent 340 to the customer client device(s) 100. For example, suppose that the notification 500 reminds a customer to add items 410 to the shared shopping list 400 and is sent 340 to a customer client device 100 associated with the customer. In this example, the online concierge system 140 may receive 345 a response from the customer client device 100 indicating that the customer has accessed the shared shopping list 400, that the customer needs more time to add items 410 to the shared shopping list 400, that the customer does not intend to add items 410 to the shared shopping list 400, etc. In various embodiments, the online concierge system 140 may receive 345 a response to the notification 500 in association with various types of information (e.g., information identifying a customer associated with the response, information describing a time the response was received 345, etc.). In some embodiments, the online concierge system 140 may make various determinations (e.g., using the user interaction module 212) based on one or more responses to the notification 500 received 345 from the customer client device(s) 100. In the above example, the online concierge system 140 may determine a difference between a time that the notification 500 was sent 340 for display to the customer client device 100 and a time that the response was received 345 from the customer client device 100. In this example, the difference may be stored (e.g., in the data store 240) in association with various types of information (e.g., information identifying the customer, the content of the response, order data for an order including items 410 in the shared shopping list 400 once the order is placed, etc.).

In various embodiments, upon receiving 345 a response from a customer client device 100 to the notification 500, the online concierge system 140 may generate 350 (e.g., using the notification generation module 218) an additional notification 500 based on the response. In such embodiments, the online concierge system 140 may then send 355 (e.g., using the content presentation module 210) the additional notification 500 for display to one or more customer client devices 100. For example, suppose that the notification 500, which includes a reminder to add items 410 to the shared shopping list 400, is sent 340 to a customer client device 100 and a response is received 345 from the customer client device 100 indicating that a customer associated with the customer client device 100 needs 10 minutes to add items 410 to the shared shopping list 400. In this example, based on the response, the online concierge system 140 may generate 350 an additional notification 500 indicating that the customer needs 10 minutes to add items 410 to the shared shopping list 400 and the online concierge system 140 may send 355 the additional notification 500 to another customer client device 100 from which a request to place an order including items 410 in the shared shopping list 400 was received.

In various embodiments, once an order including the item(s) 410 in the shared shopping list 400 has been placed, the online concierge system 140 may generate 350 an additional notification 500 that indicates a timeframe within which customers associated with the shared shopping list 400 may still add items 410 to the shared shopping list 400 in order for the items 410 to be included in the order. In such embodiments, the timeframe may be determined by the online concierge system 140 (e.g., using the order management module 220) based on a time that the online concierge system 140 assigns the order to a picker for service, based on an estimated amount of time that it would take the picker to collect one or more items 410 included in the order, etc. For example, once an order including the item(s) 410 in the shared shopping list 400 is placed, the online concierge system 140 may generate 350 the additional notification 500 that describes a timeframe for adding additional items 410 to the shared shopping list 400, in which the timeframe ends when a picker servicing the order has collected the item(s) 410 in the shared shopping list 400. The online concierge system 140 may then send 355 the additional notification 500 for display to customer client devices 100 associated with the customers associated with the shared shopping list 400. In some embodiments, the online concierge system 140 also may update the timeframe or generate 350 one or more additional notifications 500 with updated timeframes (e.g., as the online concierge system 140 tracks the progress of the picker using the order management module 220) and send 355 the additional notification(s) 500 for display to the customer client devices 100.

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising, at a computer system comprising a processor and a computer-readable medium:
receiving, at an online concierge system, information describing one or more interactions with a shopping list by at least one user of a plurality of users, wherein the shopping list is associated with the plurality of users;
identifying a set of attributes associated with the shopping list, wherein the set of attributes is based at least in part on the one or more interactions;
accessing a machine learning model trained to predict a time that a user of the plurality of users will place an order comprising one or more items included in the shopping list, wherein the machine learning model is trained by:
receiving historical data associated with one or more previous orders, wherein the one or more previous orders are associated with the plurality of users, and
training the machine learning model based at least in part on the historical data;
applying the machine learning model to the set of attributes associated with the shopping list to predict the time that the user will place the order;
generating a notification based at least in part on the time that the user is predicted to place the order; and
sending the notification to one or more client devices associated with one or more users of the plurality of users, wherein sending the notification causes the one or more client devices to display the notification.

2. The method of claim 1, wherein the historical data comprises one or more of: information identifying one or more items included in each previous order, a number of items included in each previous order, a frequency with which a shopping list associated with each previous order was accessed, a frequency with which the one or more previous orders were placed, a frequency with which an item was included in the one or more previous orders, a retailer associated with each previous order, a retailer associated with a shopping list associated with each previous order, a time at which an item was added to a shopping list associated with each previous order, information identifying a user adding an item to a shopping list associated with each previous order, a time at which each previous order was placed, information identifying a user placing each previous order, a time at which a shopping list associated with each previous order was accessed, information describing an interaction with a shopping list associated with each previous order, information identifying a user interacting with a shopping list associated with each previous order, a cost associated with each previous order, a recipe associated with each previous order, or information associated with one or more notifications associated with each previous order.

3. The method of claim 1, wherein the time that the user will place the order is predicted based at least in part on one or more of: a threshold number of items included in the shopping list, a threshold percentage of items included in the shopping list that were included in the one or more previous orders, a threshold number of items included in the shopping list that were included in the one or more previous orders, a threshold frequency with which one or more users of the plurality of users interact with the shopping list, or a threshold cost associated with the shopping list.

4. The method of claim 1, wherein the notification comprises one or more of: the time that the user is predicted to place the order, a reminder to add one or more items to the shopping list, or a suggestion to add one or more items to the shopping list.

5. The method of claim 1, wherein generating the notification comprises:
predicting a likelihood that an additional user of the plurality of users will add an item to the shopping list based at least in part on the set of attributes associated with the shopping list and the historical data; and
generating the notification based at least in part on the time that the user is predicted to place the order and the predicted likelihood that the additional user will add the item to the shopping list.

6. The method of claim 5, wherein the notification comprises one or more of: the predicted likelihood that the additional user will add the item to the shopping list or a suggestion to delay placing the order.

7. The method of claim 1, further comprising:
receiving a request from the user to place the order;
generating an additional notification describing a timeframe for adding one or more additional items to the shopping list, wherein the timeframe ends when a picker servicing the order has collected the one or more items included in the shopping list; and
sending the additional notification for display to one or more client devices associated with one or more users of the plurality of users.

8. The method of claim 1, further comprising:
receiving a response to the notification from a client device associated with an additional user of the plurality of users;
determining a difference between a time that the notification was sent for display and a time that the response was received; and
including the difference and information identifying the additional user among the historical data.

9. The method of claim 1, further comprising:
receiving a response to the notification from a client device associated with an additional user of the plurality of users;
generating an additional notification based at least in part on the response; and
sending the additional notification for display to a client device associated with the user.

10. The method of claim 1, wherein generating the notification comprises:
receiving a request from a client device associated with the user to generate the notification; and
generating the notification based at least in part on the request.

11. A computer program product comprising a non-transitory computer-readable storage medium having instructions encoded thereon that, when executed by a processor, cause the processor to: perform steps comprising:
receiving, at an online concierge system, information describing one or more interactions with a shopping list by at least one user of a plurality of users, wherein the shopping list is associated with the plurality of users;
identifying a set of attributes associated with the shopping list, wherein the set of attributes is based at least in part on the one or more interactions;
accessing a machine learning model trained to predict a time that a user of the plurality of users will place an order comprising one or more items included in the shopping list, wherein the machine learning model is trained by:
receiving historical data associated with one or more previous orders, wherein the one or more previous orders are associated with the plurality of users, and
training the machine learning model based at least in part on the historical data;
applying the machine learning model to the set of attributes associated with the shopping list to predict the time that the user will place the order;
generating a notification based at least in part on the time that the user is predicted to place the order; and
sending the notification to one or more client devices associated with one or more users of the plurality of users, wherein sending the notification causes the one or more client devices to display the notification.

12. The computer program product of claim 11, wherein the historical data comprises one or more of: information identifying one or more items included in each previous order, a number of items included in each previous order, a frequency with which a shopping list associated with each previous order was accessed, a frequency with which the one or more previous orders were placed, a frequency with which an item was included in the one or more previous orders, a retailer associated with each previous order, a retailer associated with a shopping list associated with each previous order, a time at which an item was added to a shopping list associated with each previous order, information identifying a user adding an item to a shopping list associated with each previous order, a time at which each previous order was placed, information identifying a user placing each previous order, a time at which a shopping list associated with each previous order was accessed, information describing an interaction with a shopping list associated with each previous order, information identifying a user interacting with a shopping list associated with each previous order, a cost associated with each previous order, a recipe associated with each previous order, or information associated with one or more notifications associated with each previous order.

13. The computer program product of claim 11, wherein the time that the user will place the order is predicted based at least in part on one or more of: a threshold number of items included in the shopping list, a threshold percentage of items included in the shopping list that were included in the one or more previous orders, a threshold number of items included in the shopping list that were included in the one or more previous orders, a threshold frequency with which one or more users of the plurality of users interact with the shopping list, or a threshold cost associated with the shopping list.

14. The computer program product of claim 11, wherein the notification comprises one or more of: the time that the user is predicted to place the order, a reminder to add one or more items to the shopping list, or a suggestion to add one or more items to the shopping list.

15. The computer program product of claim 11, wherein generating the notification comprises:
predicting a likelihood that an additional user of the plurality of users will add an item to the shopping list based at least in part on the set of attributes associated with the shopping list and the historical data; and
generating the notification based at least in part on the time that the user is predicted to place the order and the predicted likelihood that the additional user will add the item to the shopping list.

16. The computer program product of claim 15, wherein the notification comprises one or more of: the predicted likelihood that the additional user will add the item to the shopping list or a suggestion to delay placing the order.

17. The computer program product of claim 11, wherein the computer-readable storage medium further has instructions encoded thereon that, when executed by the processor, cause the processor to perform steps comprising:
receiving a request from the user to place the order;
generating an additional notification describing a timeframe for adding one or more additional items to the shopping list, wherein the timeframe ends when a picker servicing the order has collected the one or more items included in the shopping list; and
sending the additional notification for display to one or more client devices associated with one or more users of the plurality of users.

18. The computer program product of claim 11, wherein the computer-readable storage medium further has instructions encoded thereon that, when executed by the processor, cause the processor to perform steps comprising:
receiving a response to the notification from a client device associated with an additional user of the plurality of users;
determining a difference between a time that the notification was sent for display and a time that the response was received; and
including the difference and information identifying the additional user among the historical data.

19. The computer program product of claim 11, wherein the computer-readable storage medium further has instructions encoded thereon that, when executed by the processor, cause the processor to perform steps comprising:
receiving a response to the notification from a client device associated with an additional user of the plurality of users;
generating an additional notification based at least in part on the response; and
sending the additional notification for display to a client device associated with the user.

20. A computer system comprising:
a processor; and
a non-transitory computer-readable storage medium storing instructions that, when executed by the processor, perform actions comprising:
receiving, at an online concierge system, information describing one or more interactions with a shopping list by at least one user of a plurality of users, wherein the shopping list is associated with the plurality of users;
identifying a set of attributes associated with the shopping list, wherein the set of attributes is based at least in part on the one or more interactions;
accessing a machine learning model trained to predict a time that a user of the plurality of users will place an order comprising one or more items included in the shopping list, wherein the machine learning model is trained by:
receiving historical data associated with one or more previous orders, wherein the one or more previous orders are associated with the plurality of users, and
training the machine learning model based at least in part on the historical data;
applying the machine learning model to the set of attributes associated with the shopping list to predict the time that the user will place the order;
generating a notification based at least in part on the time that the user is predicted to place the order; and
sending the notification to one or more client devices associated with one or more users of the plurality of users, wherein sending the notification causes the one or more client devices to display the notification.
